(19) United States
(12) Patent Application Publication
(10) Pub. No.: US 2009/0231202 A1
(43) Pub. Date: Sep. 17, 2009

(54) ANTENNA STRUCTURE

(75) Inventors: Hae-soo KIM, Suwon-si (KR); Alexander Goudilev, Suwon-si (KR); Byung-sik Kim, Suwon-si (KR); Kwang-hyun Baek, Suwon-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/259,384

(22) Filed: Oct. 28, 2008

(30) Foreign Application Priority Data
Mar. 17, 2008 (KR) 2008-24368

(51) Int. Cl. H01Q 9/04

(52) U.S. Cl. 343/700 MS

(57) ABSTRACT

An antenna structure of an information communication terminal, the antenna structure including: a frame having a three dimensional shape; an antenna pattern formed in the frame; and a circuit lumped element mounted on a surface of the antenna pattern. In the antenna structure, an antenna is directly provided on the frame such that a sufficient antenna characteristic can be ensured in a small space, thereby realizing a slim and miniaturized information communication terminal.

### CROSS-REFERENCE TO RELATED APPLICATION

This application claims the benefit of Korean Patent Application No. 2008-24368, filed Mar. 17, 2008 in the Korean Intellectual Property Office, the disclosure of which is incorporated herein by reference.

### BACKGROUND OF THE INVENTION

1. Field of the Invention

Aspects of the present invention relate to an antenna structure, and more particularly, to an antenna structure having a three dimensional shape that enables a compact configuration.

2. Description of the Related Art

With recent developments in wireless communication techniques, information communication terminals (such as mobile phones, personal data assistants (PDAs), global positioning systems (GPSs), portable multimedia players (PMPs), etc.) have been popularized and generalized, and studies have been actively conducted to make the information communication terminals even more compact than present. In particular, in manufacturing slim and miniaturized information communication terminals, a design of an antenna of the terminals is particularly important. As the information communication terminals are gradually slimmed and miniaturized, an ability to mount parts is further reduced. Furthermore, in order to cope with multiple wireless services, a single information communication terminal includes a plurality of antennas. However, there is a space limitation in the installation of the multiple antennas in an information communication terminal. For example, volume occupancy of a printed board assembly (PBA) on an information communication terminal gradually increases as the information communication terminals are slimmed and miniaturized.

In order to manufacture slim and miniaturized information communication terminals, there has been proposed a printed circuit board (PCB) patch type antenna, in which an antenna pattern is realized on a PCB and a radio frequency (RF) switch is mounted on the PCB as necessary. However, a PCB patch type antenna having high efficiency cannot be realized, and there is little space for the installation of the PCB in the information communication terminals.

Meanwhile, attempts have been conducted to realize an antenna by attaching a conductive metal sheet on a frame having a three dimensional shape. However, since the metal sheet type composite antenna is made by a press process, there is a difficulty in forming a metal sheet type antenna pattern having a complex and minute shape. For example, presently, a minute antenna pattern that can be realized in the metal sheet type composite antenna has a width of only 0.8 mm. Also, since the structure of the antenna pattern formed in the metal sheet type composite antenna is formed by heat stacking, there is difficulty in soldering additional circuit lumped elements on the metal sheet type composite antenna. Furthermore, since the heat stacking occupies space, the heat stacking is not suitable for miniaturizing the antenna pattern structure. Moreover, there is a difficulty in forming an antenna pattern having a length sufficient to design an antenna due to the size limitation of a surface of the frame of the information communication terminal.

### SUMMARY OF THE INVENTION

Aspects of the present invention provide an antenna structure that is suitable for information communication terminals that are gradually miniaturized.

According to an aspect of the present invention, there is provided an antenna structure of an information communication terminal, the antenna structure including: a frame having a three dimensional shape; an antenna pattern formed in the frame; and a circuit lumped element mounted on a surface of the antenna pattern.

According to another aspect of the present invention, there is provided an antenna structure of an information communication terminal, the antenna structure including: a frame having a three dimensional shape and at least one groove; and an antenna pattern formed in the frame, wherein a portion of the antenna pattern is formed on a surface of the at least one groove.

In an aspect of the invention, the portion of the antenna pattern may be formed in a lengthwise direction of one of the grooves.

In an aspect of the invention, the portion of the antenna pattern may be formed in a direction perpendicular to the lengthwise direction of one of the grooves.

In an aspect of the invention, the circuit lumped element may be a resistor, a capacitor, and/or an inductor.

In an aspect of the invention, the antenna structure may further include a matching circuit mounted on a surface of the antenna pattern.

In an aspect of the invention, the antenna structure may further include a radio frequency (RF) signal transformation tuner mounted on a surface of the antenna pattern.

In an aspect of the invention, the antenna structure may further include an RF module mounted on a surface of the antenna pattern.

According to another aspect of the present invention, there is provided an information communication terminal, including: a frame having a three dimensional shape; and an antenna pattern formed inside the frame.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic perspective view of an antenna structure according to an embodiment of the present invention;

FIG. 2 is a schematic perspective view of an antenna structure according to another embodiment of the present invention;

FIG. 3A is a cross-sectional view of a width of a conventional antenna pattern as a comparative example;

FIG. 3B is a cross-sectional view of a width of an antenna pattern in the antenna structure of FIG. 2;

FIG. 4 is a graph showing an S parameter characteristic of the antenna structure of FIG. 2;

FIG. 5 is a schematic perspective view of an antenna structure according to another embodiment of the present invention;

FIG. 6A is a cross-sectional view of a width of a conventional antenna pattern as a comparative example;

FIG. 6B is a cross-sectional view of an antenna pattern in a lengthwise direction of the antenna structure of FIG. 5;

FIG. 7 is a graph showing an S parameter characteristic of the antenna structure of FIG. 5; and

FIG. 8 is a schematic perspective view of an antenna structure according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

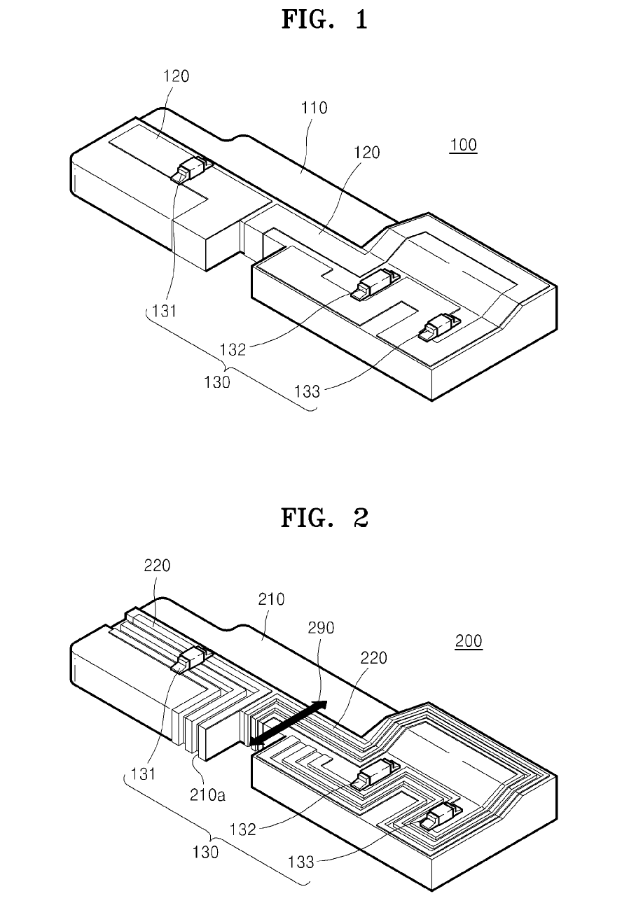

FIG. 1 is a schematic perspective view of an antenna structure 100 according to an embodiment of the present invention. Referring to FIG. 1, the antenna structure 100 includes a frame 110 having a three dimensional shape, an antenna pattern 120 formed in the antenna structure 100, and a circuit lumped element 130 mounted on the antenna pattern 120.

The three dimensional shape frame 110 may be a molded structure of an information communication terminal (for example, a molded case of a mobile phone, a PDA, a GPS, a PMP, etc.). The antenna pattern 120 is formed as a conductive metal pattern in the frame 110. For example, if the frame 110 is a molded case of an information communication terminal (such as a mobile phone), the antenna pattern 120 may be formed in an inner side of the frame 110, (i.e., within the molded case). Such an antenna pattern 120 may be formed using a molded interconnect device (MID) method in which a three dimensional electrical circuit is realized on a surface of a frame. However, it is understood that aspects of the present invention are not limited to the various MID methods. For example, the metal pattern may be formed by compressing a metal sheet. The circuit lumped element 130 includes a resistor 131, a capacitor 132, and an inductor 133, which are compositely mounted on an outer side of the frame 110 and connected to the antenna pattern 120 through openings on the frame 110. In a case where the antenna pattern 120 cannot be formed in a pattern having a sufficient length on a surface of the frame 110 due to a space limitation, a multi-band characteristic of an antenna may be realized by compositely using the circuit lumped element 130.

FIG. 2 is a schematic perspective view of an antenna structure 200 according to another embodiment of the present invention. Referring to FIG. 2, the antenna structure 200 includes a frame 210 having a three dimensional shape, and an antenna pattern 220 formed on the frame 210.

The frame 210 may be a molded structure of an information communication terminal (for example, a molded case of a mobile phone, a PDA, a GPS, a PMP, etc.). The frame 210 according to the current embodiment (i.e., the molded structure) includes at least one long groove 210a. For example, if the frame 210 is a molded case of an information communication terminal (such as a mobile phone), the long groove 210a may be formed on an inner side of the frame 210 (i.e., within the molded case of the mobile phone). The antenna pattern 220 is formed on the frame 210 using a conductive metal pattern. Furthermore, at least a portion of the antenna pattern 220 is formed to extend along a lengthwise direction of at least one of the long grooves 210a, and a cross-section of the antenna pattern 220 has a corrugated shape in a widthwise direction of the antenna pattern 220. That is, the antenna pattern 220 is formed in a corrugated shape by bending in a width direction 290 of the antenna pattern 220. Such an antenna pattern 220 may be formed by, for example, using an MID method, though it is understood that aspects of the present invention are not limited thereto, as described above.

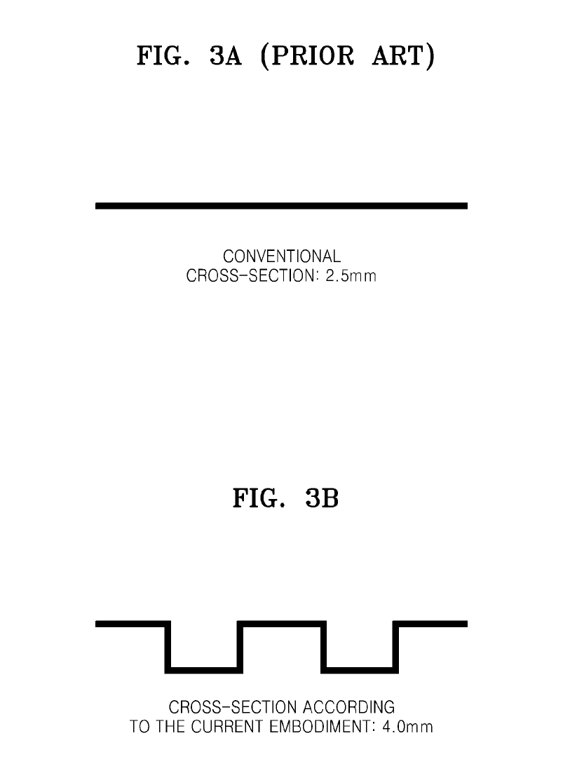

FIG. 3A is a cross-sectional view of a width of a conventional antenna pattern. FIG. 3B is a cross-sectional view of a width of the antenna pattern 220 in the antenna structure 200 of FIG. 2, for example, taken along the widthwise direction 290. Referring to FIGS. 3A and 3B, if a conventional antenna pattern formed on a flat surface of a frame is 2.5 mm, the corresponding antenna pattern 220, according to aspects of the present invention, formed on surfaces of two long grooves 210 has a width of 4.0 mm because portions of the antenna pattern 220 bend in the width direction 290 of the antenna pattern 220. In this manner, the antenna structure 200 according to the current embodiment can widen the width of the antenna pattern 220 by forming the long grooves 210 on the frame 210 that has a limited surface area. While shown as being rectangular in shape, it is understood that the corrugated cross section can have triangular, circular, or other shapes.

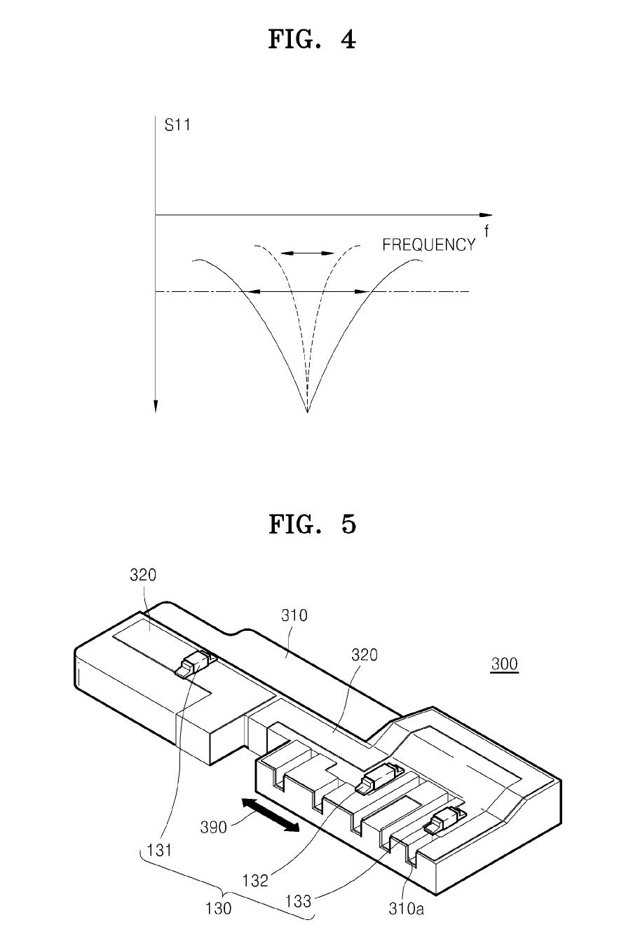

FIG. 4 is a graph showing an S parameter characteristic of the antenna structure 200 of FIG. 2. Referring to FIG. 4, the dotted line indicates an S parameter characteristic curve of the conventional antenna structure having a relatively narrow width as compared to that of the antenna structure 200, and the solid line indicates an S parameter characteristic curve of an antenna structure 200 according to the current embodiment. Referring to FIG. 4, the antenna structure 200 according to the current embodiment can achieve a greater broadband by sufficiently widening the width of the antenna pattern 220.

Referring to FIG. 2 again, the shown antenna structure 200 further includes the circuit lumped element 130 on a surface of the antenna pattern 220. The circuit lumped element 130 includes one or more of a resistor 131, a capacitor 132, and an inductor 133. The circuit lumped element 130 is described above in regards to the embodiment illustrated in FIG. 1, and thus, the description thereof will not be repeated herein. In the current embodiment, while the circuit lumped element 130 is not required in all aspects of the invention, multi-band characteristics of an antenna may be readily realized by using the circuit lumped element 130.

FIG. 5 is a schematic perspective view of an antenna structure 300 according to another embodiment of the present invention. Referring to FIG. 5, the antenna structure 300 includes a frame 310 having a three dimensional shape and an antenna pattern 320 formed in the frame 310. The frame 310 may be a molded frame of an information communication terminal (for example, a molded case of a mobile phone, a PDA, a GPS, a PMP, etc.). The frame 310 according to the current embodiment (i.e., the molded frame) includes at least one long groove 310a. For example, if the frame 310 is a molded case of an information communication terminal (such as a mobile phone), the long groove 310a may be formed on an inner side of the frame 310 (i.e., within the molded case). The antenna pattern 320 is formed in the frame 310 using a conductive metal pattern. Furthermore, at least a portion of the antenna pattern 320 is formed across a lengthwise direction of at least one of the long grooves 310a, and a cross-section of the antenna pattern 320 in a lengthwise direction 390 of the antenna pattern 320 has a corrugated shape. That is, the antenna pattern 320 is formed in a corrugated shape by bending in the lengthwise direction 390 of the antenna pattern 320. Such an antenna pattern 320 may be formed by, for example, using an MID method, though it is understood that aspects of the present invention are not limited thereto, as described above.

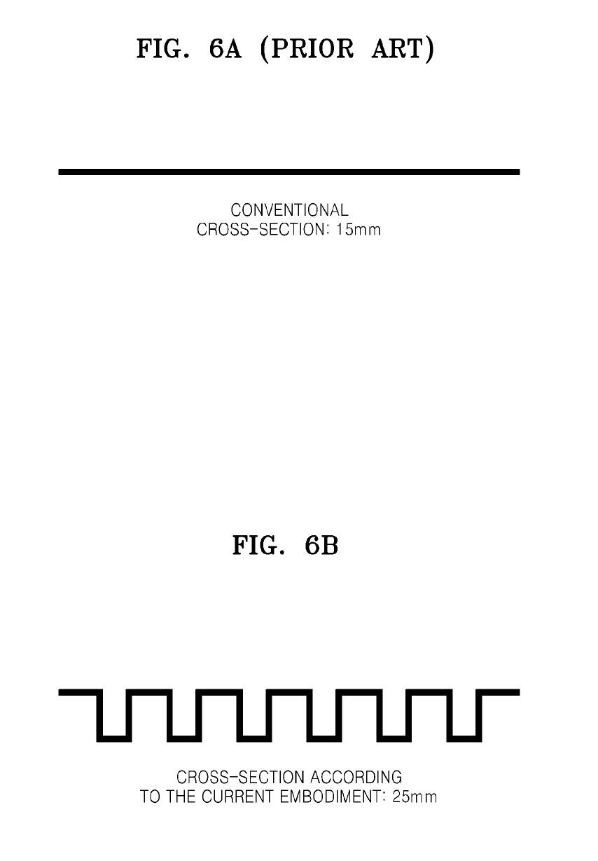

FIG. 6A is a cross-sectional view of a width of a conventional antenna pattern as a comparative example. FIG. 6B is a cross-sectional view of the antenna pattern 320 in the lengthwise direction 390 of the antenna structure 300 of FIG. 5. Referring to FIGS. 6A and 6B, if a length of a conventional antenna pattern formed on a flat surface of a frame is 15 mm, the corresponding antenna pattern 320, according to aspects of the present invention, formed on surfaces of two long grooves 310a has a length of 25 mm because the antenna pattern 320 is bent in the lengthwise direction 390 (refer to FIG. 5) of the antenna pattern 320. In this manner, the antenna structure 200 according to the current embodiment can lengthen the antenna pattern 200 by forming the long grooves 310 on the frame 310 that has a limited surface area.

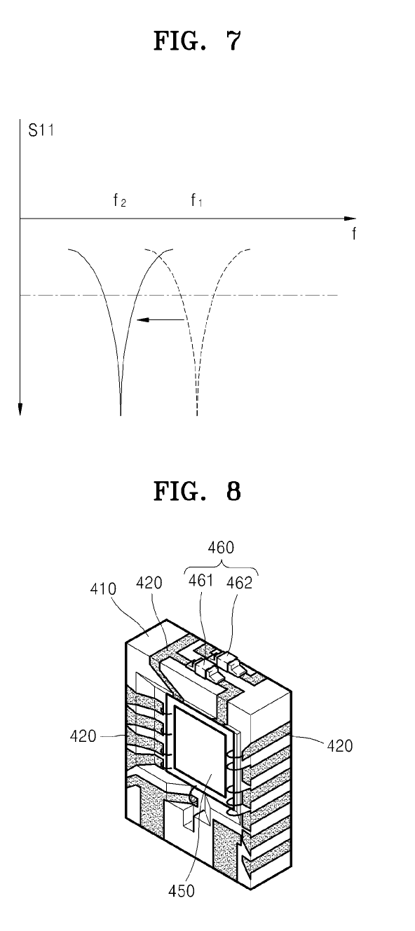

FIG. 7 is a graph showing an S parameter characteristic of the antenna structure 300 of FIG. 5. Referring to FIG. 7, the dotted line indicates an S parameter characteristic curve of a conventional antenna structure having a relatively short length as compared to that of the antenna structure 300, and the solid line indicates an S parameter characteristic curve of the antenna structure 300 according to the current embodiment. Referring to FIG. 7, the antenna structure 300 according to the current embodiment can ensure a band characteristic in a low frequency region by sufficiently lengthening the length of the antenna pattern 320. That is, the antenna structure 300 according to the current embodiment can increase a band characteristic in a low frequency region by securing a sufficient length of the antenna pattern 320 on the frame 310 that has a limited surface area.

Referring to FIG. 5 again, the antenna structure 300 further includes the circuit lumped element 130 on a surface of the antenna pattern 320. The circuit lumped element 130 includes at least one of the resistor 131, the capacitor 132, and the inductor 133. The circuit lumped element 130 is described in the foregoing embodiment, and thus, the description thereof will not be repeated herein. In the current embodiment, the circuit lumped element 130 is not required in all aspects of the invention. However, multi-band characteristics of an antenna may be readily realized by using the circuit lumped element 130.

FIG. 8 is a schematic perspective view of an antenna structure (not shown) according to another embodiment of the present invention. Referring to FIG. 8, the antenna structure includes a frame 410, an antenna pattern 420 formed in the frame 410, a radio frequency (RF) chip 450 and circuits 460 mounted on the frame 410.

The frame 410 may be, for example, a molded structure of an information communication terminal (for example, a molded case of a mobile phone, a PDA, a GPS, a PMP, etc.). The antenna pattern 420 is formed of a conductive metal pattern in the frame 410. The antenna pattern 420 may bend in a lengthwise direction and/or a widthwise direction of the antenna pattern 420 as in the foregoing embodiments. In the current embodiment, the RF chip 450 and the circuits 460, used by an antenna, are directly mounted on a portion of the antenna pattern 420. The circuits 460 may include a resistor, a capacitor, an inductor, a matching circuit, and/or an RF signal transformation tuner, which are realized by mounted parts on a surface of the antenna pattern 420. The numerical references 461 and 462 denote illustrative examples of a circuit lumped element, a matching circuit, and an RF signal transformation tuner. In this manner, since circuits of an antenna are directly mounted on the frame 410, a matching circuit, an RF signal transformation tuner, and an RF module can be integrally mounted on an antenna structure. Thus, a space occupied by the antenna structure in an information communication terminal that uses the frame 410 as a main frame can be minimized.

In the current embodiment, a matching circuit, an RF signal transformation tuner, and an RF module are described as integrally mounted on the antenna structure 400. However, it is understood that aspects of the present invention are not limited thereto. That is, the matching circuit, the RF signal transformation tuner, and the RF module may be selectively mounted on the antenna structure 400.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An antenna structure of an information communication terminal, the antenna structure comprising:
a frame having a three dimensional shape;
an antenna pattern formed in the frame; and
a circuit lumped element mounted on a surface of the antenna pattern.

2. The antenna structure as claimed in claim 1, wherein a surface of the frame comprises at least one groove, and a portion of the antenna pattern is formed on a surface of the at least one groove of the frame.

3. The antenna structure as claimed in claim 2, wherein the portion of the antenna pattern is formed in a lengthwise direction of one of the grooves.

4. The antenna structure as claimed in claim 2, wherein the portion of the antenna pattern is formed in a direction perpendicular to a lengthwise direction of one of the grooves.

5. The antenna structure as claimed in claim 1, wherein the circuit lumped element comprises a resistor, a capacitor, and/or an inductor.

6. The antenna structure as claimed in claim 1, further comprising a matching circuit mounted on the surface of the antenna pattern.

7. The antenna structure as claimed in claim 1, further comprising a radio frequency (RF) signal transformation tuner mounted on the surface of the antenna pattern.

8. The antenna structure as claimed in claim 1, further comprising an RF module mounted on the surface of the antenna pattern.

9. The antenna structure as claimed in claim 2, wherein a first portion of the antenna pattern is formed in a lengthwise direction of a first groove and a second portion of the antenna pattern is formed in a lengthwise direction of a second groove, perpendicular to the lengthwise direction of the first groove.

10. The antenna structure as claimed in claim 1, wherein a first portion of the antenna pattern bends in a first direction, and a second portion of the antenna pattern bends in a second direction, different from the first direction.

11. The antenna structure as claimed in claim 1, wherein the antenna pattern is formed as a conductive metal pattern in the frame.

12. The antenna structure as claimed in claim 1, wherein the frame is a molded case of the information communication terminal.

13. The antenna structure as claimed in claim 1, wherein the information communication terminal is a portable terminal.

14. The antenna structure as claimed in claim 1, wherein a cross section of the antenna pattern has a corrugated shape.

15. An antenna structure of an information communication terminal, the antenna structure comprising:
a frame having a three dimensional shape and at least one groove; and
an antenna pattern formed in the frame, wherein a portion of the antenna pattern is formed on a surface of the at least one long groove.

16. The antenna structure as claimed in claim 15, wherein the portion of the antenna pattern is formed in a lengthwise direction of one of the grooves.

17. The antenna structure as claimed in claim 15, wherein the portion of the antenna pattern is formed in a direction perpendicular to a lengthwise direction of one of the grooves.

18. The antenna structure as claimed in claim 15, wherein a first portion of the antenna pattern is formed in a lengthwise direction of a first groove and a second portion of the antenna pattern is formed in a lengthwise direction of a second groove, perpendicular to the lengthwise direction of the first groove.

19. The antenna structure as claimed in claim 15, wherein a first portion of the antenna pattern bends in a first direction, and a second portion of the antenna pattern bends in a second direction, different from the first direction.

20. The antenna structure as claimed in claim 15, wherein the frame is a molded case of the information communication terminal.

21. The antenna structure as claimed in claim 15, wherein the information communication terminal is a portable terminal.
